(19) United States
(12) Patent Application Publication
(10) Pub. No.: US 2003/0196895 A1
(43) Pub. Date: Oct. 23, 2003

(54) Coupling of capillary electrophoresis (CE) with mass spectrometry (MS) with optimum separation

(75) Inventors: Christian Neususs, Leipzig (DE); Matthias Pelzing, Leipzig (DE); Jochen Franzen, Bremen (DE)

Correspondence Address: KUDIRKA & JOBSE, LLP, ONE STATE STREET, SUITE 1510, BOSTON, MA, 02109, US

(73) Assignee: Bruker Daltonik GMBH, Bremen (DE)

(21) Appl. No.: 10/397,977

(22) Filed: Mar. 26, 2003

(30) Foreign Application Priority Data
Mar. 26, 2002 (DE) 102 13 390.5

(51) Int. Cl. G01N 27/26

(52) U.S. Cl. 204/451; 204/452

(57) ABSTRACT

The invention relates to methods used for mass spectrometric analysis of substances separated by capillary electrophoresis, in particular biopolymers such as proteins, proteoglycanes or other protein conjugates or their digest peptides. The invention consists in reducing the electrophoresis voltage upon appearance of the first analytically interesting substance, thereby maintaining the high separation power and gaining sensitivity. With direct coupling, e.g. by electrospray, the electrophoretic voltage may be directly controlled by the ion current measured by the mass spectrometer.

### FIELD OF INVENTION

The invention relates to methods used for mass spectrometric analysis of substances separated by capillary electrophoresis, in particular biopolymers such as proteins, proteoglycanes or other protein conjugates or their digest peptides.

### BACKGROUND OF THE INVENTION

In the analysis of biochemical polymers, in particular proteomics, separation methods with the highest possible resolution are sought in order to find alternatives to the difficult to perform 2D gel electrophoresis method. The methods mainly considered are those where mixtures of proteins or their conjugates are digested before separation to produce hundreds, if not thousands, of digest peptides which are then separated from each other and subjected to mass spectrometric analysis. The analysis is not restricted to the determination of their molecular weights but also of their structures by measuring the daughter-ion spectra of fragmented ions.

Capillary clectrophoresis (CE) has been found to be the separation method with the highest separation efficiency so far. However, the separation efficiency is usually reduced significantly by the coupling methods (CE/MS) with mass spectrometers (MS). This applies to both ionization methods for the mass spectrometers: electrospray ionization (ESI) and matrix assisted laser desorption and ionization (MALDI).

a) Capillary Electrophoresis

Different types of capillary electrophoresis are available, such as capillary zone electrophoresis (CZE), capillary gel electrophoresis (CGE), capillary isotachophoresis (ITP) and others, of which capillary zone electrophoresis is the method of particular interest in this context. An excellent discussion on using capillary zone electrophoresis for analyzing proteins can be found in the review by V. Kasicka (Electrophoresis 2001, 22, 3084-3105). The only comment which will be made here is that methods exist either with or without substance focusing for the different methods of loading the capillaries with sample solution.

Focusing methods with substance focusing are preferred for coupling with mass spectrometry provided that high separation efficiency can be maintained in the coupling. The method of coupling with mass spectrometry for the characterization of peptides and proteins is described in the review by Figeys and Aebersold (Electrophoresis 1998, 19, 885-892).

It is a basic principle of electrophoresis that the combination of substances, consisting of a dissolved mixture of molecules which are capable of dissociation, introduced in a liquid plug into the capillary, begin to migrate under the influence of a relatively strong electric field in the liquid electrolyte with which the capillary is filled. The rate of migration is different for each component in the mixture. The substances separate from each other in a similar way to the way they do in chromatography. The separation is caused by the differences in the pH-dependent charges of the molecules and their different sizes.

Capillary electrophoresis, and capillary zone electrophoresis in particular, has the great advantage over other separation methods, such as liquid chromatography, that it is capable of achieving extremely good separations within a short separation time. Thus, in less than 20 minutes, separations can be achieved with more than one million theoretical plates; plate numbers greater than 100,000 can be achieved in less than a minute.

Three partial electrical currents flow in the electrophoretic capillary: (1) the electrolytic current due to the migrating substance ions with charges which are dependent on the pH of the solution, (2) an electroosmotic current due to the effect of stationary wall charges on the solution, coupled with an electroosmotic flow of the liquid, and (3) an electrolytic current which, in most cases, is predominantly due to acids, bases or salts in the solution (the separation buffer) which determine the pH of the solution. All types of capillary electrophoresis have the advantage that the heat produced by these currents is very well dissipated by the walls of the capillary, thus making relatively high current densities possible.

The electroosmotic effect consists of an induction of mobile charges in the liquid by the stationary wall charges which in turn are produced by the liquid. The electroosmotic effect produces an electrical current as well as electroosmotic flow (EOF). Small amounts of the liquid are pumped through the capillary by the EOF. The direction and size of the current are dependent on the type of wall charges, the capillary diameter, the field strength and the polarity of the electrical field.

The wall charges can be influenced by coating the wall of the capillary with polymers. For example, negative charges are produced on the walls of an uncoated capillary. Positive wall charges are produced by bonding certain organic polymer compounds to the capillary wall, for example by aminopropylation.

Electroosmotic flow has completely different properties to the type of flow resulting from an external pressure in a capillary. Pressure which is applied externally produces a parabolic velocity profile with a velocity maximum along the axis of the capillary and zero velocity at the capillary wall. Electroosmotic flow is quite different. In this case the liquid moves through the capillary as a whole in an undistorted column and the velocity of the liquid is the same at all points across its cross section. The reason for this is that the surface of the capillary wall acts like a linear motor which slowly drives the column of liquid forward due to its effect on the charges which are induced in the liquid. The molecules travelling in a front in the liquid column therefore remain in the front and are only able to migrate out of it by very slow axial diffusion.

Due to the voltage applied externally, there is now a homogeneous electric field in the liquid column in which the substance molecules migrate. The velocity of migration in the liquid is determined by the charge on the molecules (force) and the drag (counterforce) alone—the charge being determined by the degree of dissociation of the molecule for the particular pH of the solution and the drag being determined by their shape and size. The process is similar to that found in mobility spectrometry, where the ions are pulled through a gas by an electric field. The drag is approximately proportional to the cross section of the molecule and this is determined by its molecular weight. However, it is also dependent on factors associated with its shape and the juxtaposition of the other molecules present, such as those of the solvent. The velocity increases linearly in proportion to the strength of the electric field. The separation efficiency of a capillary column of given cross section is, as a first approximation, only dependent on the length of the column (expressed as the “number of theoretical plates per unit length”). The separation efficiency is, as a first approximation, independent of the applied voltage but the voltage determines the rate of separation and therefore the time taken for an electrophoretic separation run. For most practical purposes, it is precisely the high separation rate which makes capillary electrophoresis so attractive.

On closer examination, the separation rate must not be reduced too much, as then the axial diffusion of the substances which is superimposed on the migration reduces the separation efficiency. However, this effect is very weak and the separation efficiency is practically the same over broad ranges of applied voltage. This is in sharp contrast to chromatography, where it is only the interaction between the axial and radial diffusion that produces the optimum separation efficiency. Only at the optimum liquid velocity is the optimum separation achieved; this optimum has been named after its discoverer as the van-Deemter Optimum.

Under strong acid conditions in the quartz capillary, the electroosmotic current is very small and the current velocity hardly approaches the migration rates of the slowest substance molecules.

Electrophoresis is increasingly being used in proteomics, namely for the separation of digest peptides from proteins. Either single proteins or a mixture of a large number of proteins can be digested, in which case, the mixtures will consist of approximately ten to a few thousand different peptides, depending on the initial situation. The dissociation of the digest peptides now provides charged peptide ions which, on average, possess between one and four charges in an acid medium. For example, in a 50 cm electrophoretic capillary made from quartz glass with an internal diameter of approx. 50 m, the first peptides in an acid separation buffer at a voltage of 30 kV reach the end of the capillary, where they can be picked up by a detector, after approximately 6 minutes. The slowest peptides require approximately ten minutes for this journey. After a further 5 minutes, the neutral substances, which are transported by electroosmotic flow alone, reach the end with the detector. Under these conditions, these neutral substances are not among the peptides and are of no interest to the analysis. FIG. 1 shows a typical electrophorogram. The substance plug loaded to the column was about 5 mm long, the focussing produced roughly a fivefold compression, and this means that each substance zone in the 50 m wide capillary was approximately one millimeter long.

Electrophoretic apparatuses are commercially available. They are fitted with electrophoretic voltage generators which are usually able to produce up to 30 kV. So far, they have mostly only been coupled with mass spectrometers in research laboratories, which is difficult to do and is not very widespread, unlike the widely used coupling of HPLC with mass spectrometers. One reason for this is the unsatisfactory reduction in the high electrophoretic separation efficiency which happens as a result of coupling them to mass spectrometers.

b) Ionization by Electrospray (ESI)

With electrospray, a voltage of several kV is applied across a metal capillary and a counter electrode positioned about 20 to 100 mm apart. Under the influence of the electric field at the end of the capillary, a liquid inside the capillary is electically polarized at its surface and drawn out to form a cone—the so-called Taylor cone. At the tip of the cone, the surface tension of the liquid can no longer withstand the pulling force of the electric field, which is concentrated at the tip, so small droplets which are electrically charged due to the dielectric polarization of the surface of the liquid break away. In the case of positive droplets, the electrical charge consist of protons which have been produced by the dissociation of the spray liquid. Under the influence of the inhomogeneous electrical field, the charged droplets are initially accelerated strongly away from the tip but are then decelerated in the surrounding gas, usually consisting of hot nitrogen. During flight, the droplets evaporate. If there are some larger molecules in the droplets which are more easily charged (ionized) due to protonation (or deprotonation if the polarity of the spray is reversed) than the molecules of the liquid, then the larger molecules will remain in ionized form after the liquid has completely evaporated. The ionized molecules continue to travel to the counter electrode under the influence of the electric field due to the known process of “ion mobility” and can be transferred to the vacuum system of a mass spectrometer through a fine aperture in the wall or through a capillary.

Depending on the supply of liquid in the capillaries, the droplets are generated at the extremely high rate of 10⁵ to 10⁸ per second, which usually results in the generation of a continuous ion beam. The supply is maintained by a pump, usually a spray pump, which has to operate very smoothly.

If there is a molecule in the solution which is already in ionic form, as required for separation by zone electrophoresis, the electrospray will favor ionization. This is the reason why the electrospray is the ideal ionization method for CE-MS coupling.

In this method, the larger molecules are usually not charged just once but many times—the larger the molecule, the larger the average number of elementary charges. This means that there is a wide distribution of charge numbers. As a rule of thumb, the average charge number increases by approximately 1 charge unit for every 1,000 to 1,500 atomic mass units. Large biomolecule ions can certainly be charged by as much as 10 to 50 times. Within the range of peptides which have five to twenty amino acids, the double charged ions are usually the most common. In this case, the distribution ranges from ions with 1 charge to 5 charges. The charge is usually not an ionization due to the loss of an electron but a protonation, i.e. the attachment of a positively charged hydrogen ion H⁺. For this reason, the degree of ionization also depends greatly on the hydrogen ion concentration in the solution (i.e. the pH-value).

In some respects, the multiple charge of a large molecule ion and the wide charge distribution are particularly favorable for analysis and for the detection of the ions. Although most mass spectrometers have a limited mass range (or more precisely: a limited range of mass-to-charge ratios), it is still possible to detect very large molecules far outside the mass range defined for singly charged ions in spite of this limitation. Due to the wide and regular distribution of the number of charges on the molecular ions of similar mass, it is also easily possible to determine the molecular masses by calculation. In addition to this, the multi-charged ions (especially the doubly charged ions) are particularly suitable for fragmentation, as required for scanning daughter-ion spectra.

With this method, which is normally used with metal capillaries, the droplets have a self-adjusting diameter of 1 to 2 m, which is determined by the dielectric constant, viscosity, flow rate and surface tension of the liquid. Stable operation of the electrospray can only be maintained when the liquid is flowing at significantly more than about 1 microliter per minute (apart from the so-called nanospray methods which rely on very fine-drawn capillary tips but which cannot be used for electrophoresis). Using a coaxially fed spray gas to stabilize the spray (“gas-supported spray”) has been found to be effective for flow rates of the order of 1 l per minute. The stability of operation is also determined by the properties of the spray liquid, such as the pH-value, viscosity, surface tension and conductivity. Stable spraying is only possible within relatively narrow tolerance ranges for these parameters. For this reason, the supply of a supplementary liquid which is mixed coaxially has already proved to be effective for chromatography micro-columns which only deliver a small liquid stream and for capillary electrophoresis. The supplementary liquid is able to stabilize the spray since the pH and other parameters can be adjusted by the supplementary liquid independently of the parameters of the chromatography column. However, this reduces the concentration of the analyte.

A commonly used method of coupling electrospray with capillary electrophoresis, well stabilizing the spray, consists of a central electrophoresis capillary with a small electroosmotic flow towards the spray, a coaxial spray capillary with supplementary liquid (the so-called “sheath flow”) and another external coaxial gas capillary to supply a stream of gas. In this case, capillary zone electrophoresis is regularly used. By using quartz capillaries, an electroosmotic liquid flow is generated in the direction of the spray process when a positive voltage is applied. Here, the electrophoresis capillary is pushed directly into the metal capillary for the supplementary liquid. At the spray point, the electrophoresis capillary is allowed to protrude from the coaxial metal capillary sheath for the sheath flow by about 0.2 mm. The sheath liquid is used to correct the spray parameters. A well adjusted spray gas pressure can be used to prevent additional pressure from building up in the electrophoresis capillary. This pressure would otherwise produce a pronounced parabolic velocity profile which would destroy the high separation efficiency of the electrophoresis.

However, in spite of all the precautions taken, this type of coupling (as well as all other types disclosed so far) interferes with the, in principle, high separation efficiency of capillary electrophoresis in a way which, until now, has been unavoidable and detrimental.

c) Ionization by Matrix Supported Laser Desorption and Ionization (MALDI)

The coupling of liquid separation methods with MALDI is also becoming increasingly popular for many applications since the off-line analysis makes it possible to run more time-consuming experiments which cannot be run with on-line methods due to the short time duration in which the substance peaks are available. With MALDI, as opposed to ESI, singly charged ions are predominantly generated. However, with modern MALDI mass spectrometers, outstanding daughter ion spectra can be scanned for structure determinations.

Capillary electrophoresis is usually coupled to time-separated ionization by matrix supported laser desorption and ionization systems where the outflow from the electrophoresis is guided directly to a MALDI sample support plate which is coated with a suitable matrix crystal layer. At the same time, the electrical contact between the electrophoretic liquid in the electrophoretic capillaries and the sample support plate must be maintained. The method which is usually used for coating the sample support plate is to drag the liquid column over the sample support plate while it is in contact with it in order to transfer the separately discharging substance batches into a separated spatial distribution. However, this “smeared” discharge using a drop dragged over the sample support plate similarly leads to poorer separation, as is also seen with the electrospray. Apart from this, the electroosmotic outflow from the capillary column is very small and only enables the crystal layer to be wetted very slowly so that, in this case also, the sharp separation is adversely affected.

d) Mass Spectrometry

In principle, any type of mass spectrometer can be used for analyzing spray ions since the continual generation of ions does not impose any limitations. Both the conventional sector field spectrometer and the quadrupole spectrometer are eligible and both types can be used in tandem in order to carry out MS/MS analyses.

Time-of-flight mass spectrometers require outpulsing of a laterally injected ion beam, but they can then also be used to advantage. Here, the yield of ions available for measurement is higher than it is for a sector-field or quadrupole spectrometer which acts as a filter for one single mass measured.

Particularly favorable are the storage mass spectrometers such as the quadrupole ion trap or ion cyclotron resonance instruments. These instruments are also especially suited to scanning daughter or granddaughter ion spectra, since individual ion species can be selected and fragmented in several known ways.

Time-of-flight mass spectrometers are particularly suitable for ions generated by matrix supported laser desorption and ionization (MALDI) because the ions are already generated in short pulses, which is a requirement for these instruments. Newer instruments of this type, which are known by the generic name of TOF/TOF, can also be used for scanning the daughter ion spectra of metastable or collisionally induced ions with a high level of sensitivity.

However, MALDI-generated ions can also be analyzed with the aid of storage mass spectrometers such as quadruple ion trap or ion-cyclotron resonance mass spectrometers.

The aims of mass spectrometric analysis of substances separated by electrophoresis can vary quite considerably. The simplest aim is to determine the molecular weight of proteins in mixtures precisely or to identify proteins or proteoglycanes by determining the molecular weight of decomposition products produced by enzymes, such as peptides or oligosaccharides. However, among the commonly used methods of analysis today are those used to determine parts of an amino acid sequence using MS/MS methods of different types of tandem mass spectrometry or even the analysis of the tertiary structures of large biomolecules.

e) CE/MS Coupling

Different types of coupling between capillary electrophoresis and mass spectrometry are available. Essentially, there are three types: (a) sheathless flow with nanospraying, (b) loose capillary connection with a microspray capillary (liquid junction) and (c) with sheath flow. For this invention, a coaxial arrangement of a non-electrically conductive electrophoresis capillary and an outer capillary to supply the supplementary or sheath liquid is used by preference, where the outer capillary is preferably metal in order to guide the electrophoretic stream easily.

In the case of the electrospray (ESI) this outer metal capillary and the spray capillary, can be surrounded by another capillary, the gas capillary, which stabilizes the spray with a sharp stream of gas in the usual way. This is a robust method and remains stable for days.

However, instead of a capillary, another structure can be used for an electrophoretic channel, such as a covered channel made by using microfabrication techniques. A square or rectangular cross section is just as good as a circular cross section for electrophoresis. In this respect also, there is a basic difference between this method and liquid chromatography. These types of mictrostructures can also be used to supply sheath liquids or even spray gas in order to produce a good, stable spray.

With ionization by matrix supported laser desorption (MALDI), continuous coating can be used, but the coating of separate substances on separate sample spots is preferred. Separate sample points require the electrophoretic capillary to be briefly lifted from the sample support plate each time in order to transfer it to the next sample spot. By supplying a sheath liquid, it is possible to maintain electrical contact for the electrophoretic current on the outlet side when the combined coaxial capillaries are briefly lifted from the sample support plate. The supplementary liquid also dilutes the electroosmotic flow enough for each sample spot to be covered with sufficient liquid. However, the sheath liquid is also preferred for the continuous coating in order to have enough liquid to cover the matrix layers.

The use of pneumatically supported spraying for applying the separate substances has also been disclosed.

### SUMMARY OF THE INVENTION

The basic idea of the invention is to make the time until the first electrophoretically separated substance of interest emerges as short as possible by using the highest possible electrophoretic voltage and then to reduce the voltage in order to temporally separate the substances of interest from each other as they emerge from the separation capillary. The major part of the separation takes place during the time before the first substance of interest emerges.

It is surprising that, by using this procedure, not only is the separation of substances measured by mass spectrometry improved but, on the one hand, the substance signals for each substance peak are significantly increased and, on the other hand, substances can now be detected which are not seen at all when using the normal procedure of applying a consistently high voltage. The electrophoretic peaks are only slightly broadened but the distance between them is greatly increased, as shown in FIG. 2. This method of improving the separation measured by mass spectrometry is not as trivial as it may appear. All scientists who use liquid chromatography are aware that if an analogous procedure is used in chromatography, i.e. reducing the pressure, this immediately results in poorer chromatographic separation.

The magnitude of the required reduction in the electrophoretic voltage cannot be explained by the previous knowledge of electrophoresis and electrospraying cited above. If one imagines that the substances enter the mixing space of the Taylor cone separately, one after the other, and that the cone has to be emptied before the next substance enters, then there is no explanation for why the sheath flow has to deliver a volume of liquid that would fill the Taylor cone approximately 10 to 30 times before the substance signal disappears. It is only possible to speculate about the other improvements, the increased intensity and the appearance of substances which would otherwise not be seen.

Similar effects appear with MALDI coatings. Here also, the improvement in separation is greater than expected according to general understanding and in this case also, substances are detected which were not possible to detect previously.

With this invention, therefore, not only are those substances ionized separately from each other which could only be detected in the form of mixtures when using the usual operating procedure but, as already briefly explained, substances can also be measured in their ionized form which, by using the usual operating procedure, could not be detected at all, possibly due to quenching processes during competitive ionization. The overall sensitivity of the method increases. In the case of the electrospray, due to the somewhat broader peak in terms of time, time is gained for a more detailed analysis, for example by scanning daughter ion or granddaughter ion spectra. Thus, not only can auto MS/MS methods be used but it is certainly also possible to use automated tandem mass spectrometry up to the fifth generation (MS⁵).

The timing of the reduction in electrophoretic voltage can be easily controlled, since the time window is well known and is reproducible. For the electrospray, the reduction in voltage is preferably triggered by the mass spectrometric measurement of the ion beam itself. In this case, ion beams in individual mass ranges or even ion beams containing ions of individual masses can be used to find the substances of interest. The reduction in voltage can follow a preselected voltage curve or, in the extreme, a sudden drop. The voltage can then be maintained at the lower level until all the substances of interest have been analyzed in order to then eject the remaining substances by high voltage in a shorter time.

Since the time for emptying the Taylor cone by the spray method is known for a substance, the voltage can also be raised to a preselected voltage curve again after this time if another substance batch has not already appeared.

However, the voltage can also be controlled by the strength of the selected ion beam itself, while also taking into account the known peak profile of the electrophoretic substance peak for the control. This enables the concentration of the substance in the Taylor cone to be maintained at a constant value for a brief period, for example. This mode of operation is particularly suitable for the so-called auto MS/MS method, which can be used to gain information about the structure of the ions by selecting a suitable ion species, fragmenting these ions and scanning a daughter-ion spectrum.

### BRIEF DESCRIPTION OF THE DRAWINGS

FIG. 1 shows a typical electrophorogram for a mixture of digest peptides. The appearance of the digest peptides starts after 6 minutes and ends after 10 minutes. After 15 minutes, some neutral substances appear which have been flushed out with the electroosmotic flow (EOF). These substances are not digest peptides.

FIG. 2 shows three electrophorograms for a mixture of peptides using a 55 cm×50 m×360 m capillary (length×internal diameter×external diameter):

(A) an electrophorogram at 30 kV when the invention has not been used,

(B) with the voltage reduced to 10 kV after 5 minutes and

(C) with the voltage reduced to 5 kV after 5 minutes.

FIG. 3 shows a preferred arrangement of capillaries for the electrospray. The electrophoretic capillary (1) is arranged coaxially inside the sheath liquid capillary (2), which in turn is arranged coaxially inside the spray-gas capillary (3). The sheath liquid which is transported to the tip via the sheath capillary (3) is drawn out by an electric field to form a Taylor cone (4). Droplets are generated at the tip of the cone to form a spray mist (5). In the electrophoretic capillary (1), there is a substance plug (6) which migrates in the direction of the Taylor cone (4) due to the electrophoretic voltage. In principle, the substance plug can move in its entirety from the capillary into the Taylor cone in approximately 1 to 2 seconds. However, the substance peaks measured by mass spectrometry are always 10 to 20 seconds wide.

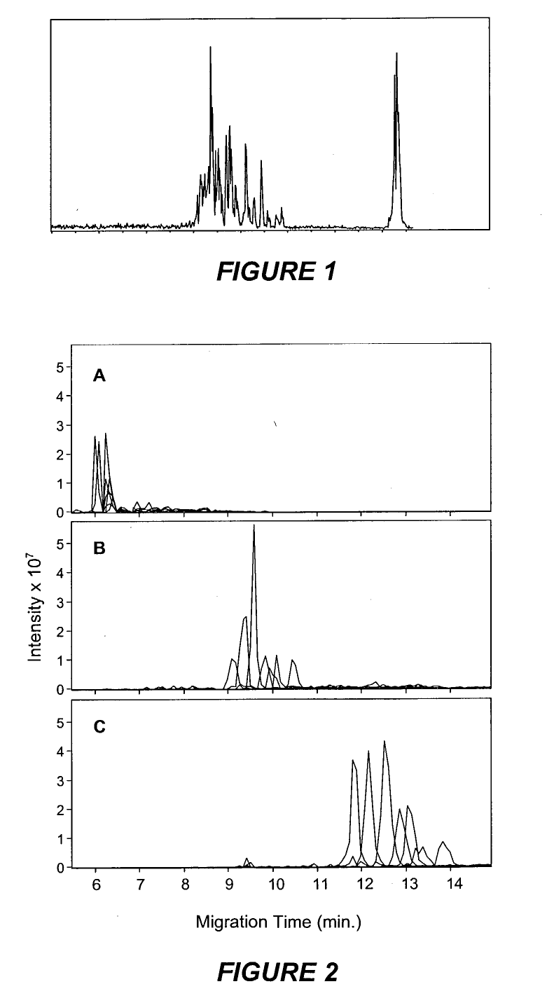

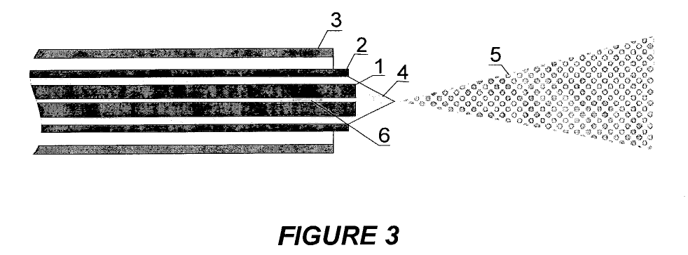

### DETAILED DESCRIPTION

The favorable embodiments for ionization by electrospray (ESI) will be given first, followed by those for ionization by matrix supported laser desorption (MALDI).

The effect of the invention is well shown in FIG. 2, exhibiting three electrophorograms for a mixture of peptides using a 55 cm×50 m×360 m capillary (length×internal diameter×external diameter) in connection with electrospray ionization:

(A) an electrophorogram at 30 kV when the invention has not been used,

(B) with the voltage reduced to 10 kV after 5 minutes and

(C) with the voltage reduced to 5 kV after 5 minutes.

There is a clear improvement in the separation because, although the widths of the substance peaks slightly increase, they do not decrease in peak hight by the expected factor of six corresponding to the slowing down of the electrophoresis. In contrast, the amplitudes of the substance peaks become significantly greater. The surface integral of the peak area, and therefore the sensitivity, is increased at least fourfold.

A buffer was used consisting of 200 millimolar formic acid and 7 millimolar ammonia aqueous solution with 10% acetonitrile. The injection was made hydrodynamically at 50 millibar with substance focusing by injecting 1 molar NH₃ for 8 seconds, injecting the sample for 60 seconds and then injecting 4 molar formic acid for 8 seconds. Electrospraying was carried out using a sheath liquid consisting of isopropanol and water in equal parts at the rate of 2 l per minute at 4,000 volts.

Here, capillary electrophoresis with sheath liquid and gas spraying is used, a method which allows the spray to be adjusted and remain stable for days at a time. However, this robust operation does not provide sufficiently good separation of complex mixtures of substances without using the invention.

As explained above, an electrophorogram for a mixture of digest peptides at 30 kV electrophoretic voltage in a 75 m electrophoresis quartz glass capillary 56 cm long takes approximately 15 minutes before the appearance of the last substance peaks (which represent neutral substances and are flushed out of the column with the electroosmotic flow). Only the digest peptides of interest appear after 6 minutes and these remain for only 4 minutes.

One favorable embodiment according to this invention consists in reducing the electrophoretic voltage from 30 kV to 7.5 kV after 6 minutes. This reduces both the migration rate and the electroosmotic flow rate to a quarter of the previous value in each case. The digest peptides now appear over a period of 16 minutes, their mass spectra are much better separated and the larger temporal width of the substance peaks allow for more favorable analyses procedures in terms of the daughter-ion spectra. After 16 minutes, the voltage is raised to 30 kV again in order to flush all remaining neutral substances from the capillary. (It is also possible to flush out the substances faster by applying pressure). The total time taken for the electrophoresis is 32 minutes if the time for feeding the substance in, about 5 minutes, is included. Of the 32 minutes, the mass spectrometer only uses 16 for the measurement. With this mode of operation, it is also possible to couple an expensive mass spectrometer to two economically priced electrophoresis apparatuses.

The advantages of the method according to the invention are the improved separation of the substances and the additional detection of many substances which could not be detected at all by the methods normally used up to now. The advantages in all probability stem from the fact that, although the electrophoretically separated substances pass into the Taylor cone in very short bursts of about a second, they do not immediately mix with supplementary liquid located there. It seems possible that, due to the spray suction, the sheath liquid is primarily drawn along the outside of the Taylor cone to the tip and is sprayed out from there, and that the electrophoretically separated substances can only diffuse into this flow slowly. In fact, eddy currents may even be set up in this zone. Since substances sprayed simultaneously can impede each other's ionization during electrospraying (the terms used for this is “quenching”), but sequential spraying is now used, more substances can be detected with this invention than is possible without it, and the substances appear better separated even if the time taken required is longer.

Due to the choice of voltage reduction, the invention allows a compromise between fast analysis time and good separation to be selected which is appropriate for the problem.

Although the electrophoresis speed is slowed down, the separation process does not deteriorate. This is surprising to the chromatography specialist because it is in stark contrast to analogous analytical experiments carried out in liquid chromatography, where an equivalent reduction in the pressure always results in much poorer separation. Only the so-called stop-flow mode, where the pressure is removed completely, has proved to be successful to some extent in chromatography. In this case, the deterioration in separation is only moderate because the diffusion is relatively slow. On the other hand, by reducing the pressure, the operator is working in an unfavorable region of the Deemter diagram and this has a detrimental effect on the separation process which has already started. However, the stop-flow mode can only be used for a few types of spectrometry such as nuclear magnetic resonance spectrometry. In mass spectrometry, this mode of operation is not possible because mass spectrometry requires a constant supply of the substance.

Reducing the electrophoretic voltage and switching the high voltage on again is easy to control temporally since the times are well known. The reduction can follow a preselected voltage curve or, in the border case, a sudden drop. The voltage can then be maintained at the lower level until all substances of interest have been analyzed, and then the remaining substances can be ejected more quickly at the high voltage.

In another preferred embodiment, the voltage reduction is triggered by the ion beam measurement itself. Here also, the voltage can remain at the lower level until the substance of interest has been analyzed. Different substances of interest can be selected by the choice of masses or mass ranges within which the ion beam is integrated to trigger or control the voltage.

However, the voltage does not have to be maintained at this lower level, and especially not when only relatively few substances of analytical interest are separated. Since the time is known for emptying the Taylor cone of a substance by the spraying process, the voltage can be raised again on a preselected voltage curve, provided that no other interesting substance peak has already appeared. Each new interesting substance peak triggers a drop and rise in voltage.

However, in another preferred embodiment of the invention, the voltage can also be controlled by the strength of the ion beam within selected mass ranges. (Or, more precisely, it is always the mass-to-charge ratio ranges which can be selected, since all mass spectrometers specificly measure this ratio.) In this case, a control function can be used into which the known peak profile of the electrophoretic substance peak is introduced in addition to the control system. This can enable, for example, a constant concentration of a substance in the Taylor cone to be maintained over a short period of, say, ten to twenty seconds—a mode of operation which is particularly suitable for scanning daughter-ion spectra. In this case, measurement is carried out using the so-called auto MS/MS method. It is possible to scan the daughter-ion spectrum by selecting a suitable ion species, usually the double-charged ions of the substance, and fragmenting this ion species using known means and methods. The daughter-ion spectra provide information about the structure of the ions. The spectral scan takes about 1 to 1.5 seconds in an ion-trap mass spectrometer. There is therefore still time to scan one or more granddaughter ion spectra of selected daughter ions by a so-called auto MS/MS/MS method. (Comparable times are needed to scan daughter-ion spectra in other types of mass spectrometer.)

The analysis of a partial proteome, such as a fraction of a cell aggregate which contains only certain organelles with an estimated 5,000 different proteins may be carried out as follows: the proteins are digested with trypsin to produce approximately 10,000 to 50,000 different digest peptides. This mixture is separated into approximately 96 fractions by using reverse-phase liquid chromatography. Each of these fractions contains about 100 to 500 digest peptides. These fractions are separated automatically using electrophoresis in an ion-trap mass spectrometer which is fitted with two automatic electrophoresis instruments, the digest peptides being measured according to the invention in each case by the mass spectrometer every 15 minutes. By using auto MS/MS, it is possible to obtain the daughter-ion spectra for each digest peptide. Measurement of all the proteins of the partial proteomes then takes exactly 24 hours.

Of course, the separations of the substances is not so complete that they no longer overlap. In general (providing there are no unfavorable quenching processes taking place or extreme concentrations present), the measurement of two, three or even four overlapping substances can still provide good results using mass spectrometry. If the appearance of a substance can be recognized at all in an MS spectrum, then by using mass spectrometry to isolate its ions with the auto MS/MS method, this substance will be clearly seen as a meaningful daughter-ion spectrum. A single daughter-ion spectrum of a single digest peptide is normally sufficient to identify a protein.

One such method of partial proteome analysis can also be carried out well via MALDI ionization. A preferred coupling of capillary electrophoresis to MALDI for the proteome analysis with a few hundred digest peptides uses sample support plates the size of microtitre plates, on which, for example, 1536 hydrophilic anchor surfaces in a hydrophilic environment are provided as sample sites. In a favorable embodiment, the anchor sites with diameters ranging from 400 to 600 m, for example, are coated with a crystalline layer of -cyano-4-hydroxycinnamic acid. This substance is later used in the MALDI process as the matrix for ionization. First, however, it is mainly used as a peptide trap, since, due to its high affinity, it is excellent for binding all peptides practically without exception. The sheath flow at the end of the electrophoretic capillary is adjusted to approx. 30 l per minute. The end of the combination capillary is transferred from sample to sample by a robotic arm every second, droplets containing 500 nanoliters being deposited in each case. These droplets have a diameter of about 1 mm. They are held in position by the hydrophilic anchor. The digest peptides are held affinitively to the thin-layer matrix. The droplets dry and are restricted to the hydrophilic anchor surfaces. However, each of the droplets can also be removed after a short period of about 30 seconds because by then, the digest peptides have almost quantitatively fixed themselves to the tiny crystals of the matrix substance.

With a cycle of 1 second, it takes about 25 minutes to coat 1536 sample sites. When using an electrophoretic capillary under the operating conditions mentioned above, reducing the electrophoretic voltage to 5 kV means that all peptides can be put down on the plate separately. The sample support plate can then be carefully washed. After drying, it has proved to be expedient to dissolve the thin crystalline layer again by dispensing a mixture of methanol, acetonitrile and acetone and recrystallize it. This greatly increases the sensitivity for the digest peptides.

These sample support plates can be very effectively analyzed by using the tandem time-off-light mass spectrometers (TOF/TOF) which are just appearing on the market. These time-off-light mass spectrometers are not only able to measure the primary spectra (MS spectra) of the digest peptides, which essentially only indicate the molecular weights, but also the daughter-ion spectra of selected primary ions. These daughter-ion spectra supply information about the structure. Partial sequences of the amino acid chain can usually be read off immediately. The advantage of using MALDI analysis for digest peptides is that there is sufficient time to carry out the analysis, since this method is not dependent on the short time span which is available in a substance peak produced when using direct coupled on-line methods.

However, the sample support plates can also be coated with the matrix substance completely or in connected tracks. It is possible to place the samples on these plates both as spots and as connected tracks, such as a meander or a spiral.

The eluates from the electrophoretic capillary and the sheath liquid can also be deposited on the sample support plates by nebulization of a spray gas. The eluates can be deposited either as spots and as connected tracks.

Using -cyano-4-hydroxycinnamic acid is only mentioned as an example. Of course, the entire range of hundreds of MALDI matrices can be used here, depending on the task in hand. Also, the matrix substances do not have to be deposited on the sample support plates beforehand; they can, for example, be deposited together with the sheath liquid. The specialist, once informed of the basic principles of the invention and its surprising results, can easily adapt the methods to his particular requirements.

1. Method for coupling electrophoresis in capillaries or microchannels for the separation of substances in a mixture to mass spectrometric analysis of the thus separated substances, where certain groups of substances are of particular interest,
wherein the electrophoretic voltage is kept as high as possible until the substances of interest appear and is then reduced for the analysis of the substances of interest.

2. Method according to claim 1 wherein the electrophoretic voltage is raised again after the substances of interest have passed through.

3. Method according to claim 1 wherein a sheath liquid is supplied coaxially at the end of the electrophoretic capillary.

4. Method according to claim 1 wherein the substances separated by electrophoresis are ionized by electrospray and measured in a mass spectrometer.

5. Method according to claim 4 wherein the reduction of the electrophoretic voltage and, where applicable, the raising of the voltage are controlled by the mass spectrometric measurement.

6. Method according to claim 4 wherein the degree to which the electrophoretic voltage is reduced is controlled by the size of the ion signals measured by mass spectrometry.

7. Method according to claim 6 wherein the control system takes into account the known time curve of the ion beams for a substance.

8. Method according to claim 1 wherein the substances separated by electrophoresis are deposited on a sample support plate for ionization by matrix supported laser desorption and ionization.

9. Method according to claim 8 wherein the substances separated by electrophoresis are deposited in the form of droplets on matrix coatings which have been prepared beforehand.

10. Method according to claim 9 wherein the sites of deposition for the substances are separate from each other.

11. Method according to claim 10 wherein the sites of deposition are separated from each other by hydrophobic areas.

12. Method according to claim 8 wherein the sites of deposition form a connected track.

13. Method according to claim 8 wherein the substances separated by electrophoresis are sprayed onto the sample support plate.

14. Method according to claim 8 wherein the matrix substance is applied together with the substances separated by electrophoresis.
